(19) United States
(12) Patent Application Publication
(10) Pub. No.: US 2011/0303777 A1
(43) Pub. Date: Dec. 15, 2011

(54) Horizontal paper removal device of a shredder

(75) Inventor: Jia-Wang Jiang, NingBo City (CN)

(73) Assignee: Michilin Prosperity Co., Ltd., SanChung City (TW)

(21) Appl. No.: 12/801,436

(22) Filed: Jun. 9, 2010

(51) Int. Cl. B02C 23/02

(52) U.S. Cl. 241/101.2

(57) ABSTRACT

A paper removal device of a shredder has a belt transporting mechanism between a blade set and a paper outlet. Shredded paper chips first fall onto the belt and transported horizontally to the end of paper outlet. They then fall downward into a collecting bin. Since the paper removal device separate the blade set and the paper outlet, the user will not touch the blade set even if he or she carelessly put the hand into the paper outlet.

### BACKGROUND OF THE INVENTION

1. Field of Invention

The invention relates to a shredder and, in particular, to a cross-cut shredder that has a horizontal paper removal device between its blade set and paper outlet.

2. Related Art

According to their mechanical cutting methods, shredders can be classified as stripe-cut shredders that cut paper into stripes and cross-cut shredders that cut paper into chips.

The shredding head of the strip-cut shredder can be used independently. The shredding head of the cross-cut shredder must be accompanied with a trash bin. The reason is that the lower part of the shredding head of the cross-cut shredder is an open paper outlet. When the shredding head and the trash bin are separate, its user may hurt himself by putting his hand into the paper outlet and getting cut by the running blades. To prevent this, the shredding head of the cross-cut shredder has to have a safety switch and the trash bin is usually provided with a protruding block corresponding to the switch. When the shredding head and the trash bin are combined, the protruding block urges against the safety switch so that the shredder is power-on and can run normally. When the shredding head and the trash bin are separate, the protruding block leaves the safety switch so that the safety switch automatically turns off the power for the shredder. In this case, the user will not get hurt by the blades even if he puts his hand into the paper outlet.

Since the shredding head of the cross-cut shredder has to be used with the accompanying trash bin, instead of itself alone, the production and transportation costs of existing cross-cut shredders are higher and inconvenient for carrying.

### SUMMARY OF THE INVENTION

In view of the foregoing, the invention provides a cross-cut shredder that is simpler in structure, easy to use, lower in production and transportation costs.

To achieve the above objective, the invention provides a cross-cut shredder that includes an upper cover, a lower cover, a motor and gearbox, and a blade set. The upper cover and the lower cover are connected to form a housing. The motor and gearbox, and the blade set are all disposed in the housing. The upper cover has a paper inlet above the blade set. The lower cover has a paper outlet underneath the blade set. The invention is featured in that a horizontal paper removal device is disposed between the blade set and the paper inlet.

The horizontal paper removal device is a belt transportation mechanism disposed between the blade set and the paper outlet. The paper chips from the blade set first fall onto the belt and transported horizontally to one end of the paper removal device. They then fall into a collecting trash bin. Since the paper removal device is disposed between the blade set and the paper outlet, it separates the blade set from the paper outlet. Therefore, even if the user puts his hand into the paper outlet, he still will not touch the blade set. This effectively prevents the user from getting hurt because he carelessly puts his hand into the paper outlet. As a result, the disclosed cross-cut shredder does not need a safety switch or a trash bin while the user safety can be guaranteed. Apparently, the production and transportation costs of the disclosed cross-cut shredder can be lowered. The invention is also very portable.

### BRIEF DESCRIPTION OF THE DRAWINGS

These and other features, aspects and advantages of the invention will become apparent by reference to the following description and accompanying drawings which are given by way of illustration only, and thus are not limitative of the invention, and wherein:

FIG. 1 is a transverse cross-sectional view of the invention; and

FIG. 2 is a longitudinal cross-sectional view of the invention.

### DETAILED DESCRIPTION OF THE INVENTION

The present invention will be apparent from the following detailed description, which proceeds with reference to the accompanying drawings, wherein the same references relate to the same elements.

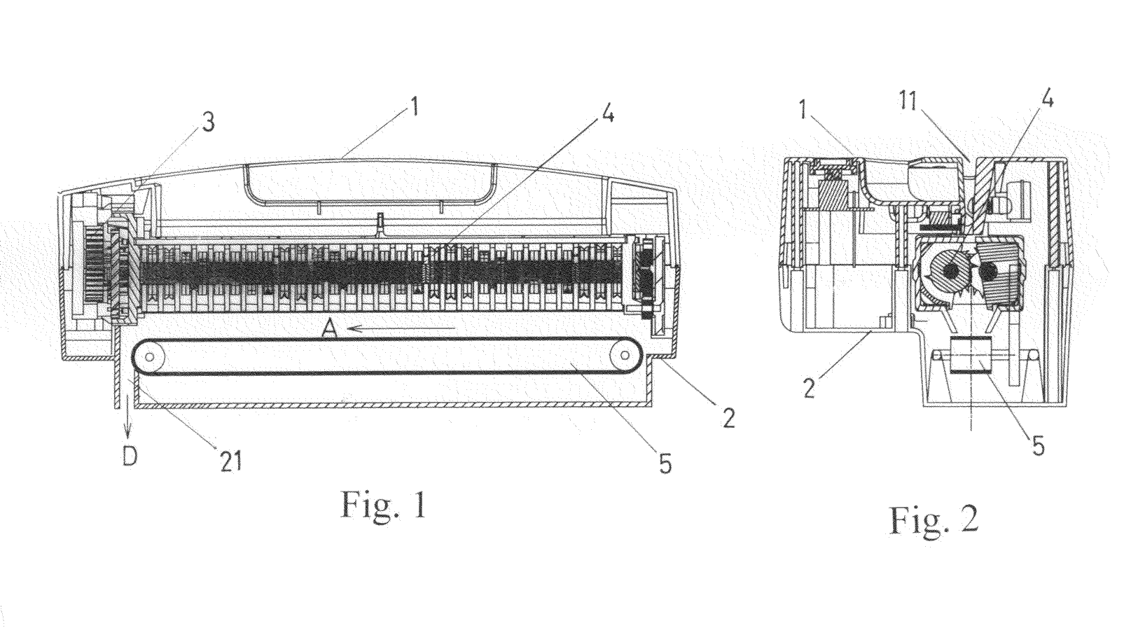

Please refer to FIGS. 1 and 2. The invention includes an upper cover 1, a lower cover 2, a motor and gearbox 3, and a blade set 4. The upper cover 1 and the lower cover 2 are connected to form a housing. The motor and gear box 3 and the blade set 4 are installed in the housing. The upper cover 1 has a paper inlet 11 above the blade set 4. The lower cover 2 has a paper outlet 21 underneath the blast set 4. The invention is featured in that a horizontal paper removable device 5 is disposed between the blade set 4 and the paper outlet 21.

The paper removal device 5 is a belt transportation device. Paper chips from the blade set 4 first fall onto the belt, and then transported horizontally to one end of the paper removal device as indicated by the arrow A. They fall from the paper outlet 21 into the trash bin (not shown), as indicated by the arrow D, achieving the goal of removing trash paper. Since the paper removal device 5 is disposed between the blade set 4 and the paper outlet 21 to separate them apart, the user will not touch the blade set 4 even if he puts his hand into the paper outlet 21. This effectively prevents the user from getting hurt by the blades when he puts his hand into the paper outlet 21.

It is apparent that the disclosed cross-cut shredder does not need a safety switch or a trash bin. The user's safety is still guaranteed. Moreover, the production and transportation costs of the cross-cut shredder can be significantly reduced. The disclosed cross-cut shredder is also portable.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A horizontal paper removal device of a shredder, comprising:
an upper cover;
a lower cover;
a motor and gear box; and
a blade set of cutting blades;
wherein the upper cover and the lower cover are connected to form a housing; the motor and gear box and the blade set are fixed in the housing;
the upper cover has a paper inlet above the blade set; the lower cover has a paper outlet underneath the blade set; and a horizontal paper removal device is disposed between the blade set and the paper outlet so that paper chips produced by the blade set first fall onto the paper removal device, then are transported to one end of the paper removal device, and fall into a trash bin.

2. The horizontal paper removal device of a shredder as in claim 1, wherein the paper removal device is a belt transporting mechanism.
